(19) United States
(12) Patent Application Publication
(10) Pub. No.: US 2005/0231025 A1
(43) Pub. Date: Oct. 20, 2005

(54) Wheel support rolling bearing unit and manufacturing method therefor

(75) Inventors: Masahiro Yasumura, Fujisawa-shi (JP); Shoji Horike, Fujisawa-shi (JP)

Correspondence Address: CROWELL & MORING LLP;INTELLECTUAL PROPERTY GROUP, P.O. BOX 14300, WASHINGTON, DC, 20044-4300, US

(73) Assignee: NSK Ltd., Tokyo (JP)

(21) Appl. No.: 11/102,629

(22) Filed: Apr. 11, 2005

(30) Foreign Application Priority Data
Apr. 20, 2004 (JP) 2004 124295

(51) Int. Cl. B60B 27/00

(52) U.S. Cl. 301/105.1

(57) ABSTRACT

It's an object of the invention to precisely match a mounting surface 14 of a mounting flange 13 for fixedly supporting a rotor, with a virtual plane perpendicular to the rotation axis of a hub 8b, to thereby prevent judder which occurs at the time of braking. For that purpose, a processing jig is pressed into the inner peripheral surface of an unfinished hole formed in the mounting flange 13 to form female serrations and make mounting holes 15, after which the mounting surface 14 is subjected to finishing. Then a male serration portion 16 of a stud 9 is loosely fitted into the mounting hole 15. As a result, deterioration of the accuracy of the mounting surface 14 accompanying fitting of the male serration portion 16 can be prevented.

### FIELD OF THE INVENTION

The present invention relates to improvements to a wheel support rolling bearing unit which supports a wheel of a vehicle on a suspension unit, and to a manufacturing method therefor. In particular, the invention realizes a construction and a method whereby deformation of a flange accompanying fitting and supporting the base end portion of a stud in a mounting hole formed in a flange formed on an outer peripheral surface of a rotation ring, can be kept unrelated to the occurrence of an unpleasant vibration and noise at the time of braking.

### BACKGROUND OF THE INVENTION

By means of a construction for example as shown in FIG. 15, a wheel 1 constituting a wheel of a vehicle, and a rotor 2 constituting a disc brake, being a braking device that is a rotation member used for braking, are rotatably supported on a knuckle 3 constituting a suspension unit. That is to say, in a circular support hole 4 portion formed in the knuckle 3 is fixedly connected a rolling bearing unit 5 for wheel support as shown in FIG. 16. That is, an outer ring 6 being a stationary ring, constituting the wheel support rolling bearing unit 5 is fixedly connected by means of a plurality of bolts 7 to the knuckle 3. On the other hand, on a hub 8 being a rotating ring, constituting the wheel support rolling bearing unit 5, a wheel 1 and a rotor 2 are fixedly connected by means of a plurality of studs 9 and nuts 10.

Double row outer ring raceways 11a and 11b are formed on the inner peripheral surface of the outer ring 6, and a coupling flange 12 is formed on the outer peripheral surface. Such an outer ring 6 is secured to the knuckle 3 by connecting the coupling flange 12 to the knuckle 3 with the bolts 7. On the other hand, on one part of the outer peripheral surface of the hub 8 on a portion protruding from the outside end opening of the outer ring 6 (“outside” in relation to the axial direction, is the outside in the widthwise direction of the vehicle in a condition when assembled on the vehicle, the right side in the figures. On the other hand, the left side in the figures which becomes the central side in the widthwise direction of the vehicle in a condition assembled on the vehicle is called the “inside”. The same applies throughout this specification), a mounting flange 13 is formed. The wheel 1 and the rotor 2 are fixedly connected by means of the studs 9 and the nuts 10 to a mounting surface 14 being the outside surface of the two axial side surfaces of the mounting flange 13.

Specifically, round shape mounting holes 15 at a plurality of locations around the circumferential direction near the outer peripheral portion of the mounting flange 13 are respectively formed in a condition axially passing through the mounting flange 13. By inserting the studs 9 into the mounting holes 15 from the inside surface side of mounting flange 13, the male serration portion 16 formed on the outer peripheral surface towards the end of the base end (the left end in FIG. 15) of the respective studs 9 is press fitted into the mounting hole 15 (the male serration portion 16 which has been subjected to hardening such as induction hardening is cut into the inner peripheral surface of the mounting hole 15). Together with this, a rim portion 17 formed on the base end portion of the respective studs 9 is abutted against the inside surface of mounting flange 13. As a result, in a condition with the studs 9 fixedly fastened to the mounting flange 13, the male threaded portion 18 formed on the tip end portion (the right end in FIG. 15) of the studs 9 protrudes from the outside surface of the mounting flange 13. The portion of the studs 9 which protrudes from the outside surface of the mounting flange 13 is inserted into the plurality of holes formed in the portion near the inner periphery of the rotor 2 and the wheel 1, and the inside surface of the rotor 2 is overlapped on the outside surface of the mounting flange 13, and the inside surface of the wheel 1 is overlapped on the outside surface of the rotor 2. Then, by screwing and further tightening the respective nuts 10 onto the portion of the male threaded portion 18 which protrude from the outside surface of the wheel 8, the wheel 1 and the rotor 2 are securely connected to the outside surface of the mounting flange 13.

On the outer peripheral surface of the intermediate portion of the hub 8, on the portion which faces the outside outer ring raceway 11a of the aforementioned double row outer ring raceways 11a and 11b, is formed an inner ring raceway 19a. Furthermore, on a small diameter step portion 20 formed on the inside end portion of the hub 8, an inner ring 21 is externally fitted. An inner ring raceway 19b formed on the outer peripheral surface of this inner ring 21 is made to face the inside outer ring raceway 11b of the double row outer ring raceways 11a and 11b. Furthermore, a plurality of rolling elements 22 are provided so as to roll freely between these outer ring raceways 11a and 11b, and the inner ring raceways 19a and 19b.

As shown in the figure, since this is a wheel support rolling bearing unit 5 for the driven wheel (the front wheel of a front engine front wheel drive vehicle, the rear wheel of a front engine, middle engine or rear engine, rear wheel drive vehicle, and all wheels of a four wheel drive vehicle), a spline hole 23 is formed in the central portion of the hub 8. A spline shaft 25 of a constant velocity joint 24 is inserted into this spline hole 23. When using the wheel support unit constructed in this manner, the rotor 2, and a support and a caliper (not shown in the figure) which are fixed to the knuckle 3, are assembled together to constitute the disc brake for braking. At the time of braking, a pair of pads provided on both sides of the rotor 2 are pressed against the opposite side surfaces of the rotor 2.

As the wheel support rolling bearing unit for rotatably supporting a wheel on a suspension system such as the knuckle 3, there is known a device such as shown in FIG. 17 through 30 in addition to the construction as shown in FIGS. 15 and 16.

Of these, in the case of a second example shown in FIG. 17, this is used for comparatively large vehicle use, when a comparatively large moment load must be supported. Here the spacing in the axial direction of the hub 8, of the rolling elements 22 arranged in the double row is much wider than for the case of the first example shown in FIGS. 15 and 16.

In the case of a third example shown in FIG. 18, by means of a crimped portion 26 formed by plastically deforming the inside end portion of the hub 8b radially outwards, the inside end surface of the externally fitted inner ring 21 is held against the inner diameter step portion 20 of the hub 8b.

In a fourth example as shown in FIG. 19, the construction of the third example is applied to the undriven wheel (the rear wheel of a front engine front wheel drive vehicle, and the front wheel of a front engine, middle engine or rear engine, rear wheel drive vehicle), and the hub 8c has a solid body without a spline hole.

In the case of a fifth example shown in FIG. 20, the crimped portion 26 (refer to FIG. 19) is removed from the aforementioned fourth example, and instead a nut 27 screwed onto the inside end portion of the hub 8d is used to press the inside end surface of the externally fitted inner ring 21 against the small diameter step portion 20 of the hub 8d.

In the case of a sixth example shown in FIG. 21, in order to construct the wheel support rolling bearing unit for use with a heavy vehicle, then for the plurality of rolling elements 22a provided for each row, tapered rollers are used. To match these, outer ring raceways 11c and 11d, and inner ring raceways 19c and 19d respectively provided in double rows, are made as a conical concave shape and a conical convex shape. In the example in the figures, not only the inside inner ring raceway 19d, but also the outside inner ring raceway 19c are formed on the outer peripheral surface of separate inner rings 21a externally fitted to the middle portion of the hub 8e.

In the case of a seventh example shown in FIG. 22, an outside inner ring raceway 19c is formed directly on the outer peripheral surface of the middle portion of the hub 8e.

In the case of an eighth example shown in FIG. 23, a hub 8f being a rotating ring surrounding a pair of inner rings 21b which are stationary rings, is rotatably supported via rolling elements 22.

In the case of a ninth through fifteenth example shown in FIG. 24 through 30, a threaded hole 36 for screwing a bolt, is formed in the respective mounting flanges 13. In the case where the bolt is secured to this mounting flange 13, the wheel is fastened by bolts which are inserted from the outside and screwed into the threaded holes 36 and tightened.

Of the examples 9 through 15 shown in FIG. 24 through 30, for the construction other than where the threaded hole 36 is formed instead of securing the stud to the flange 13, the ninth example shown in FIG. 24 is the same as the first example shown in FIG. 16, the tenth example shown in FIG. 25 is the same as the third example shown in FIG. 18, the eleventh example shown in FIG. 26 is the same as the fourth example shown in FIG. 19, the twelfth example shown in FIG. 27 is the same as the fifth example shown in FIG. 20, the thirteenth example shown in FIG. 28 is the same as the sixth example shown in FIG. 21, the fourteenth example shown in FIG. 29 is the same as the seventh example shown in FIG. 22, and the fifteenth example shown in FIG. 30 is the same as the eighth example shown in FIG. 23.

Also in the case of the wheel support rolling bearing unit having any of the constructions shown above in FIG. 15 through 23, the studs 9 for securely connecting the wheel 1 or the rotor 2 (refer to FIG. 15) to the mounting flange 13 formed on the outer peripheral surface of the hub 8, 8a, 8b, 8c, 8d, 8e and 8f, are previously securely supported in the mounting flange 13. That is to say, as is apparent from FIG. 15, these studs 9 are inserted from the axial inside to the outside into the mounting holes 15 formed in the mounting flange 13. However in the condition where the wheel support rolling bearing unit is fitted to the suspension system, the knuckle 3 or the constant velocity joint 24 become an obstruction, so that assembly of the studs 9 into the mounting flange 13 is difficult. Consequently, it is necessary to previously insert the studs 9 into the mounting holes 15. Furthermore, in the stage of handling the wheel support rolling bearing unit, during the time from transporting the wheel support rolling bearing unit from the manufacturing site to the vehicle assembly site, and then assembling in the vehicle suspension system, it is necessary to prevent the studs 9 from dropping out from the mounting holes 15. The reason for this is in order to avoid difficulties of the studs 9 being lost from dropping out, and the difficulty with reassembling into the mounting holes 15. Furthermore, in order to securely connect the wheel 1 or the rotor 2 to the mounting flange 13, when screwing the nuts 10 (refer to FIG. 15) onto the tip ends of the studs 9 and tightening, it is also necessary to prevent the studs 9 from turning.

Therefore, conventionally, as described above, the studs 9 are inserted into the mounting holes 15 from the inside surface side of the mounting flange 13, and the male serration portions 16 provided on the outer peripheral surface of the portion towards the middle base end of the studs 9 is press fitted into the mounting holes 15. However, when the studs 9 are secured in the mounting holes 13 in this manner, the mounting holes 13 are slightly deformed. That is to say, when the male serration portion 16 of the stud 9 is press fitted into the mounting hole 15 formed in the mounting flange 13, the inner peripheral surface of the mounting hole 15 is strongly pressed in the radially outward direction of the mounting hole 15 as shown by the arrow in FIG. 31, by the male serration portion 16. As a result, in the mounting flange 13, the peripheral portion of the mounting holes 15 is deformed with a warp.

Furthermore, at the portion into which the male serration portion 16 is inserted, as described above, not only is the inner peripheral surface of the mounting hole 15 pressed and expanded, but also the peripheral portion of the inner peripheral surface of the mounting hole 15 is pressed forward in the pressing direction. As a result, as shown exaggerated in FIG. 32, the material of the outer peripheral portion flows forward in the pressing direction, and a swollen portion 28 is formed on the peripheral portion of the respective mounting holes 15 of the outside surface of the mounting flange 13. The swelled amount of the swollen portions 28 formed in this manner is not only uneven in relation to the peripheral direction of the swollen portions 28, but is also uneven between the respective swollen portions 28.

In this manner, the mounting flange 13 is deformed accompanying the press fit of the male serration portion 16 of the respective studs 9 into the respective mounting holes 15. Therefore the accuracy of the mounting surface 14 of the mounting flange 13 is poor. More specifically, the deviation of the mounting surface 14 from a virtual plane perpendicular to the rotation axis of the hubs 8a, 8b, 8c, 8d, 8e, and 8f is large. In the case where the rotor 2 is supported and secured on the mounting surface 14 with such poor accuracy, the rotational runout accuracy of the braking friction surface (both side surfaces of the outer diameter side portion) of the rotor 2 is poor, and with rotation of the hub 8a, 8b, 8c, 8d, 8e and 8f, the respective braking friction surfaces oscillate in the axial direction. As a result, partial wear of the pads and the braking friction surfaces occurs, and an abnormal noise referred to as judder occurs at the time of braking.

Heretofore as technology for preventing the occurrence of the aforementioned undesirable situation, there is known the technology disclosed in Patent Documents 1 through 3 (U.S. Pat. No. 6,415,508, Japanese Patent Application Publication No. 2002-46408 and Japanese Patent Application Publication No. 2003-326908). Of these, a first example of conventional technology disclosed in Patent Document 1 is related to a method where after press fitting the studs into the mounting holes, the swollen portion formed on the outside surface of the mounting flange accompanying this press fitting is removed by turning or grinding. A second example of the conventional technology disclosed in Patent Document 2 is related to a construction for preventing the formation of the swollen portion on the outside surface of the mounting flange accompanying the press fitting, by forming concavities around the periphery of the mounting holes in the outside surface of the mounting flange prior to press fitting the studs into the mounting holes. Furthermore, in a third example of the conventional technology disclosed in Patent Document 3, a dummy plug having a slightly smaller diameter than the male serration portion provided on the stud is press fitted into the mounting hole formed in the mounting flange, and machining of the mounting surface is performed in a condition with the mounting flange deformed. Then, the male serration portion of the stud is press fitted into the mounting hole instead of the dummy plug.

Of the abovementioned conventional technologies, in the case of the first example disclosed in Patent Document 1, the swollen portion formed on the outside surface of the mounting flange must be shaved off, so that chips and shavings which are produced at the time of turning or grinding are likely to become attached to the raceway surface. Then, if the adhered shavings or chips are left as is, it becomes difficult to maintain the durability of the wheel support rolling bearing unit. Therefore a cleaning operation is necessary to remove the shavings or chips after the turning or grinding, which causes an increase in manufacturing costs of the wheel support rolling bearing unit.

Moreover, since the turning or grinding is made in a condition with the wheel support rolling bearing unit assembled, a coolant cannot be used for performing the turning or grinding. Therefore, for example, the life of the cutting tool used in the turning is less compared to when a coolant is used, which causes an increase in manufacturing costs of the wheel support rolling bearing unit. Furthermore, the chips which are produced at the time of turning and which attach to the wheel support rolling bearing unit, come into contact with the outside surface of the mounting flange and cause damage such as scoring of the outside surface, so that there is the possibility of the flatness of the outside surface being furthermore worsened.

In the case of the second example disclosed in Patent Document 2, since the concavities are provided in the outside surface of the mounting flange, not only is the strength of the mounting flange reduced, but also it is not possible to take measures against the deformation of the mounting flange towards the warp direction.

In the case of the third example disclosed in Patent Document 3, since the male serration portion of the stud is press fitted into the mounting hole, the mounting flange is still nevertheless slightly deformed accompanying the press fit (interference). Recently, it has become necessary to make the runout of the rotor even less, and it has become necessary to make the deformation of the mounting flange even less. Therefore the case of the third example also has room for improvement.
[Patent Document 1] U.S. Pat. No. 6,415,508
[Patent Document 2] Japanese Patent Application Publication No. 2002-46408
[Patent Document 3] Japanese Patent Application Publication No. 2003-326908

### SUMMARY OF THE INVENTION

The wheel support rolling bearing unit and manufacturing method therefor of the present invention takes into consideration the above mentioned situation, and has been invented in order to keep to a minimum the degradation in accuracy of the mounting surface of the mounting flange accompanying supporting the studs in the mounting holes.

The wheel support rolling bearing unit, which is the object of the present invention, and the wheel support rolling bearing unit to be manufactured by the manufacturing method therefore, being the object of the present invention, both comprise; a stationary ring and a rotating ring which are combined together concentric with each other and are rotatably supported relative to each other via a plurality of rolling elements; a flange provided on an outer peripheral surface of the rotating ring for fixedly supporting a wheel and a brake rotation member on a mounting surface being an axial side face thereof; and mounting holes provided at a plurality of locations around the circumferential direction of the flange in a condition axially piercing the flange.

Furthermore, in the case of the wheel support rolling bearing unit which is the object of the wheel support rolling bearing unit and manufacturing method therefor of the present invention, a base end portion of each of the plurality of studs is supported in each mounting hole by internally fitting a male serration portion provided on the base end portion of the studs into a female serration formed on the inner peripheral surface of the mounting hole.

In particular, in the wheel support rolling bearing unit according to the present invention, the mounting surface is made a flat surface perpendicular to the rotation axis of the rotating ring, by burnishing which is applied in a condition with the stationary ring, the rotating ring and the rolling elements assembled together.

Furthermore, in the case of the manufacturing method for a wheel support rolling bearing unit according to the present invention, the mounting flange is made a flat surface by subjecting the mounting surface to burnishing in a condition with the stationary ring, the rotating ring and the rolling elements assembled together.

Here burnishing is a processing method as prescribed in JIS B 0106, being a method which finishes the machined surface to a desired condition by rubbing a hard cutting tool against the machined surface (mounting surface) to thereby generate plastic flow of the machined surface, without chips being produced from the machined surface.

In the wheel support rolling bearing unit according to the present invention, the female serrations on the inner peripheral surface of the mounting holes are formed. Then, the mounting surface is made into a flat surface perpendicular to the rotation axis of the rotating ring by finishing which is applied after forming the female serrations by means of the processing jig, in the inner peripheral surface of the mounting holes.

Furthermore, in the case of the manufacturing method for a wheel support rolling bearing unit according to the present invention, the female serrations are formed in the inner peripheral surface of the mounting holes. Then, by subjecting the mounting surface to finishing, the mounting surface is made a flat surface perpendicular to the rotational axis of the rotating ring. Then the base end portions of the studs are fitted into the mounting holes.

In the wheel support rolling bearing unit according to the present invention, the female serrations on the inner peripheral surface of the mounting holes are formed in a larger diameter than that of the male serration portion, by broaching the plurality of unfinished holes formed in the flange. Then, the mounting surface is made a flat surface perpendicular to the rotational axis of the rotating ring, by finishing processing which is applied after forming the female serrations by the broaching on the inner peripheral surface of the mounting holes.

In the case of the manufacturing method for a wheel support rolling bearing unit according to the present invention, the female serrations with a larger diameter than that of the male serration portion are formed by broaching the plurality of unfinished holes formed in the flange. Then, by subjecting the mounting surface to finishing, the mounting surface is made into a flat surface perpendicular to the rotation axis of the rotating ring, after which the base end portions of the studs are fitted into the mounting holes.

In the wheel support rolling bearing unit and manufacturing method therefor according to the present invention, the female serrations and the male serration portion are of course serration engaged so as to prevent relative rotation.

According to the wheel support rolling bearing unit and manufacturing method therefor of the present invention constructed as described above, the deterioration in accuracy of the mounting surface of the flange accompanying supporting the respective studs in the flange is kept to a minimum. Moreover, the accuracy of the mounting surface can be increased as required without producing shavings. Therefore manufacturing cost increase can also be suppressed.

At first, in the case of the wheel support rolling bearing unit and manufacturing method therefor according to a first embodiment of the present invention, by burnishing in a condition with the wheel support rolling bearing unit assembled, the mounting surface is made a desired flat surface. Therefore, there is no occurrence of shavings, giving an improvement in the accuracy of the mounting surface of the mounting flange.

Furthermore, in the case of the wheel support rolling bearing unit and manufacturing method therefor according to a second embodiment of the present invention, the finishing process is applied to the mounting surface after forming the female serrations on the inner peripheral surface of the mounting holes. Therefore any deterioration in accuracy of the mounting surface accompanying machining of the female serrations can be compensated for. Moreover, regarding the male serration portion of the stud, since this is loosely fitted into the mounting hole, there is no deformation of the mounting flange accompanying fitting of the male serration portion.

### BRIEF DESCRIPTION OF THE DRAWINGS

FIG. 1 is a cross-sectional view of a hub provided with an unfinished hole, in an intermediate process of the first through third examples.

FIG. 2 is a cross-sectional view showing a condition immediately before inserting a processing jig into the unfinished hole in an intermediate process of the first and second examples.

FIG. 3 is a cross-sectional view showing a condition where the processing jig is inserted into the unfinished hole in the intermediate process of the first and second examples.

FIG. 4 is a cross-sectional view showing a condition where the processing jig is extracted from the unfinished hole in an intermediate process of the first and second examples.

FIG. 5 is a cross-sectional view showing a condition where a mounting surface is subjected to finishing processing in an intermediate process of the first example.

FIG. 6 is a cross-sectional view showing a condition where a stud is inserted into a mounting hole in an intermediate process of the first example.

FIG. 7 is a cross-sectional view showing a condition of finishing processing the mounting surface, in an intermediate process of second and third examples.

FIG. 8 is a cross-sectional view showing a condition where a stud is inserted into the mounting hole, in an intermediate process of the second and third examples.

FIG. 9 is a cross-sectional view showing a condition where a hub provided with an unfinished hole and other constructional members are assembled together, in an intermediate process of the third example.

FIG. 10 is a cross-sectional view showing a condition immediately before inserting a processing jig into the unfinished hole, in an intermediate process of the third example.

FIG. 11 is a cross-sectional view showing a condition where the processing jig is inserted into the unfinished hole in the intermediate process of the third example.

FIG. 12 is a cross-sectional view showing a condition where the processing jig is extracted from the unfinished hole in an intermediate process of the third example.

FIG. 13 is a cross-sectional view of a hub provided with a threaded hole, in an intermediate process of a fourth example.

FIG. 14 is a cross-sectional view showing a condition where a mounting surface is subjected to finishing processing, in an intermediate process of the fourth example.

FIG. 15 is a cross-sectional view showing a condition where a first example of a wheel support rolling bearing unit being an object of the present invention, is assembled.

FIG. 16 is a cross-sectional view showing the wheel support rolling bearing unit of the first example demounted.

FIG. 17 is a cross-sectional view showing a second example of a wheel support rolling bearing unit being an object of the present invention.

FIG. 18 is a cross-sectional view showing a third example of the wheel support rolling bearing unit being an object of the present invention.

FIG. 19 is a cross-sectional view showing a fourth example of the wheel support rolling bearing unit being an object of the present invention.

FIG. 20 is a cross-sectional view showing a fifth example of the wheel support rolling bearing unit being an object of the present invention.

FIG. 21 is a cross-sectional view showing a sixth example of the wheel support rolling bearing unit being an object of the present invention.

FIG. 22 is a cross-sectional view showing a seventh example of the wheel support rolling bearing unit being an object of the present invention.

FIG. 23 is a cross-sectional view showing an eighth example of the wheel support rolling bearing unit being an object of the present invention.

FIG. 24 is a cross-sectional view showing a ninth example of the wheel support rolling bearing unit being an object of the present invention.

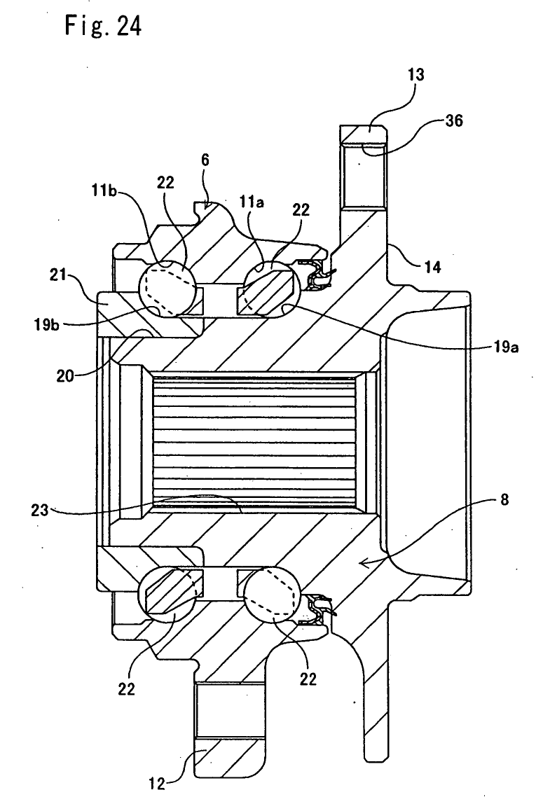

FIG. 25 is a cross-sectional view showing a tenth example of the wheel support rolling bearing unit being an object of the present invention.

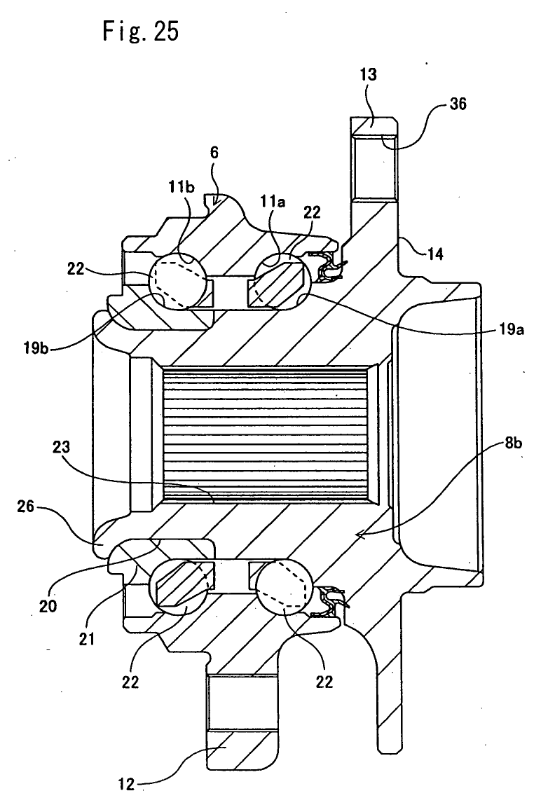

FIG. 26 is a cross-sectional view showing an eleventh example of the wheel support rolling bearing unit being an object of the present invention.

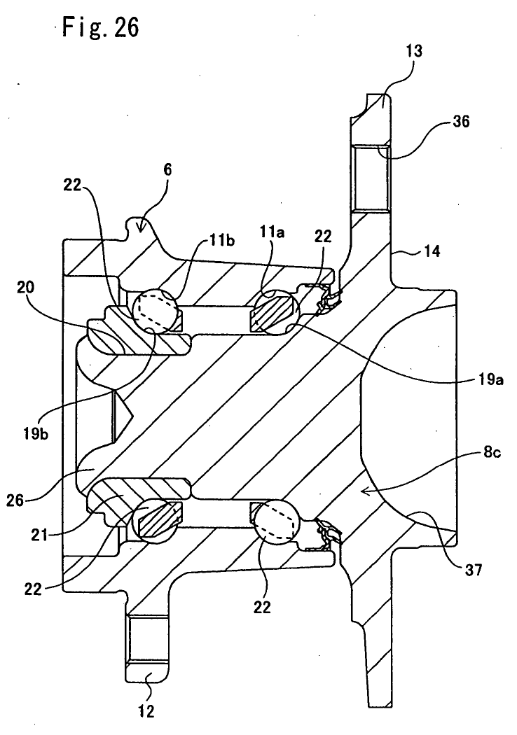

FIG. 27 is a cross-sectional view showing a twelfth example of the wheel support rolling bearing unit being an object of the present invention.

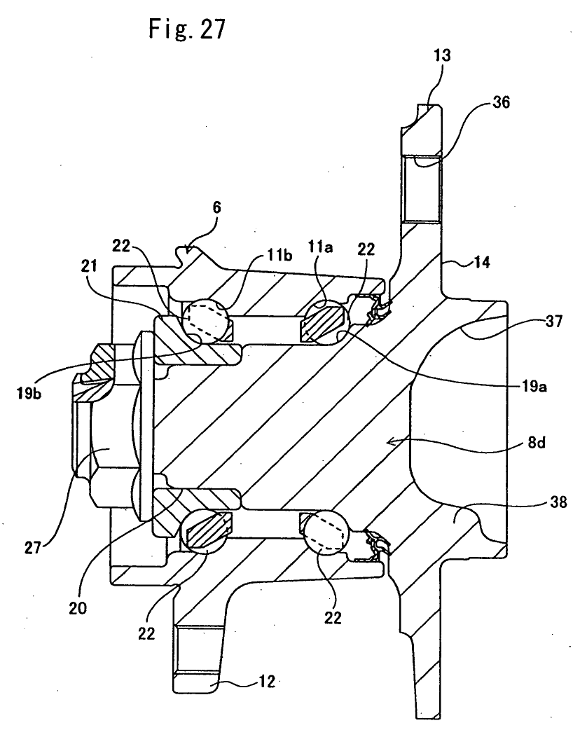

FIG. 28 is a cross-sectional view showing a thirteenth example of the wheel support rolling bearing unit being an object of the present invention.

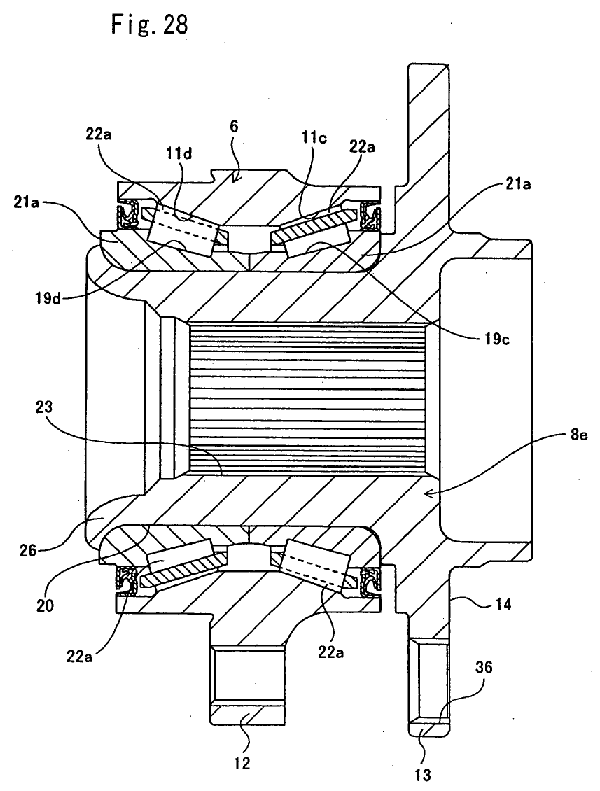

FIG. 29 is a cross-sectional view showing a fourteenth example of the wheel support rolling bearing unit being an object of the present invention.

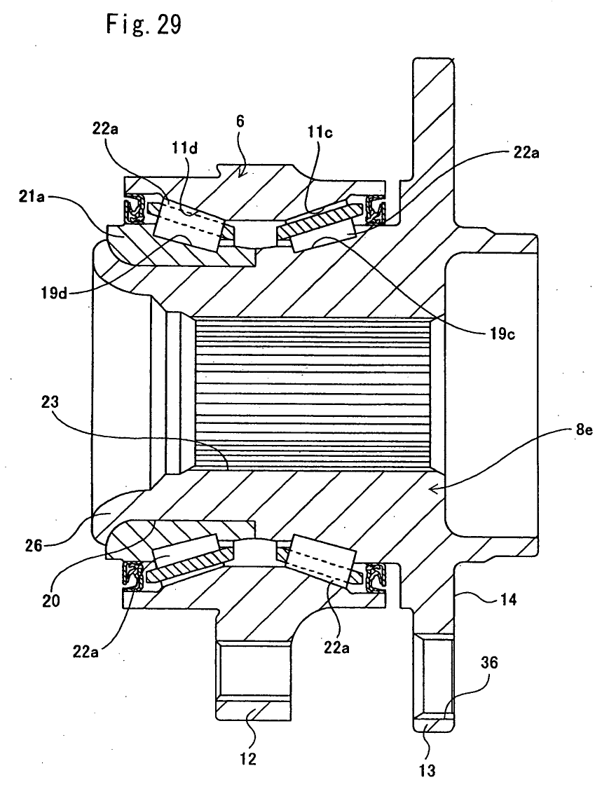

FIG. 30 is a cross-sectional view showing a fifteenth example of the wheel support rolling bearing unit being an object of the present invention.

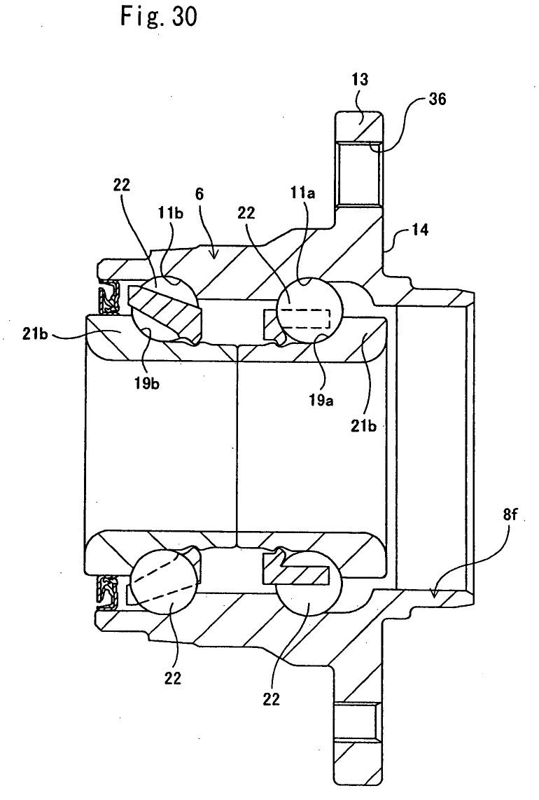

FIG. 31 is a partial cross-sectional view showing an enlarged portion, for explaining a first reason for deformation of the mounting surface of the mounting flange accompanying press fitting of a stud.

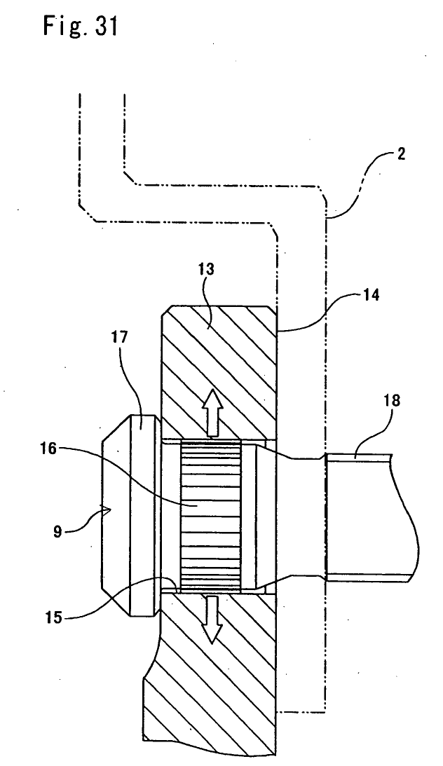

FIG. 32 is a partial cross-sectional view showing an enlarged portion, for explaining a second reason for deformation of the mounting surface of the mounting flange accompanying press fitting of the stud.

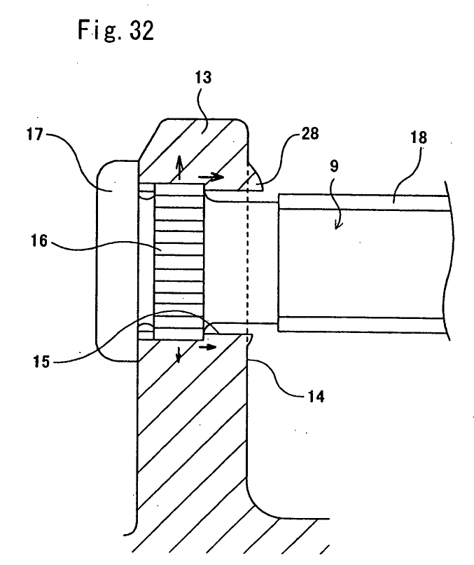

### DETAILED DESCRIPTION OF THE INVENITON

Preferably in the case of implementing the wheel support rolling bearing unit according to the present invention, a retaining means for preventing the base end portion of the studs from coming out from the mounting holes, is provided between the mounting holes and the studs.

This retaining means, for example, may be an adhesive which bonds the male serration portion to the female serrations.

Alternatively, this may be an O-ring externally fitted to a portion of the stud which protrudes from the mounting surface of the flange, at an intermediate portion of the stud. In this case a chamfer or countersink is formed in the peripheral portion of the opening of the mounting hole on the mounting surface side, in order to accommodate the O-ring in at least an elastically compressed condition.

If constructed in this manner, then even in the case where the male serration portion of the studs are loosely engaged in the mounting holes, the studs can be prevented from dropping out from the mounting holes in the stage of handling the wheel support rolling bearing unit, during the time from transporting the wheel support rolling bearing unit from the manufacturing site to the vehicle assembly site, and then assembling into the vehicle suspension system.

Preferably in the case of implementing the wheel support rolling bearing unit according to the present invention, the finishing process for the mounting surface is performed while rotating the rotating ring with respect to the stationary ring, with the stationary ring, the rotating ring, and the rolling elements assembled together.

If constructed in this manner, then irrespective of errors in the assembly of the respective members (stationary ring, rotating ring, rolling elements) constituting the wheel support rolling bearing unit, the mounting surface can be highly accurately matched on the virtual plane perpendicular to the central rotation axis of the rotating ring.

### First Example

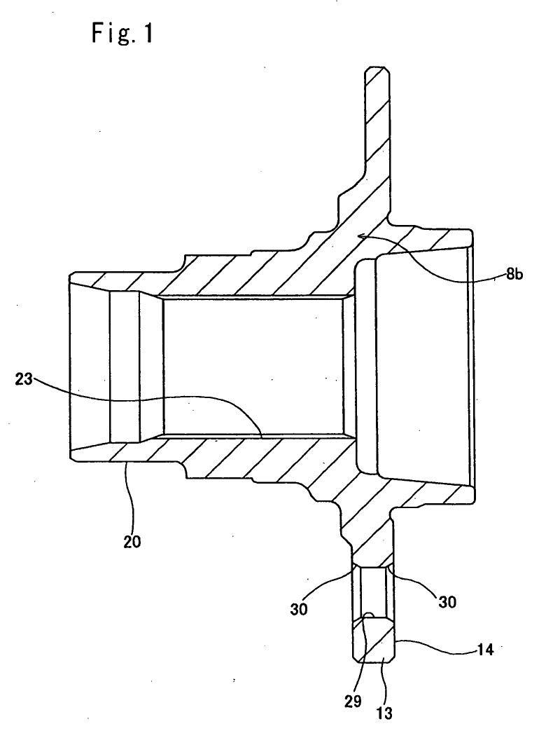

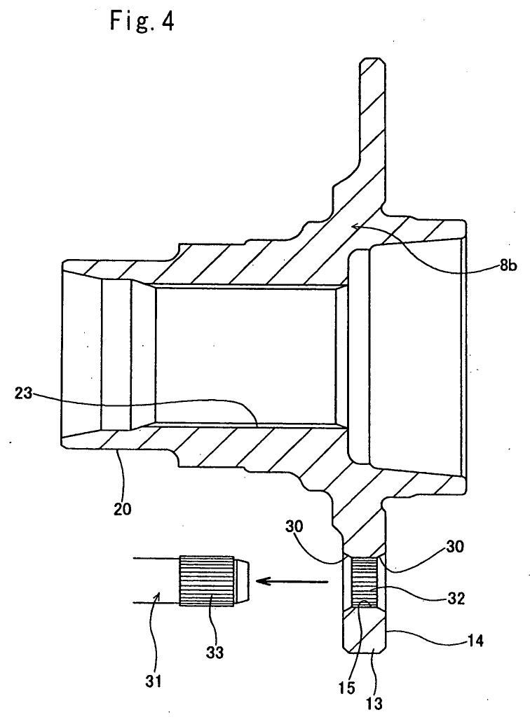

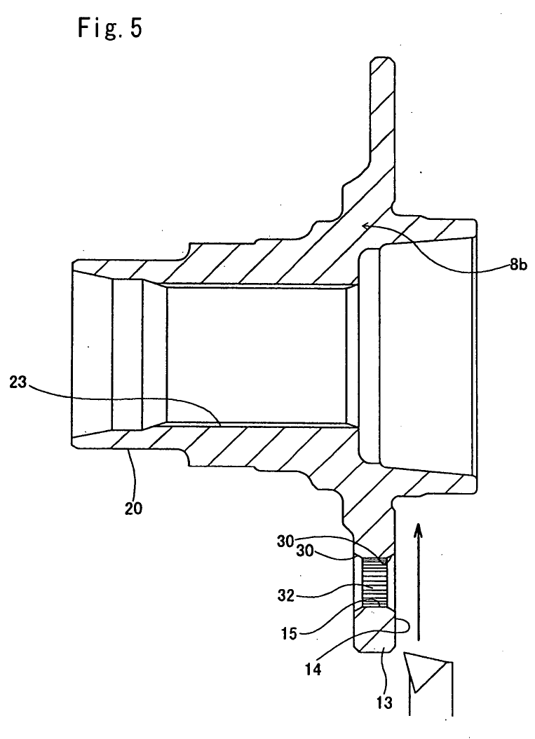

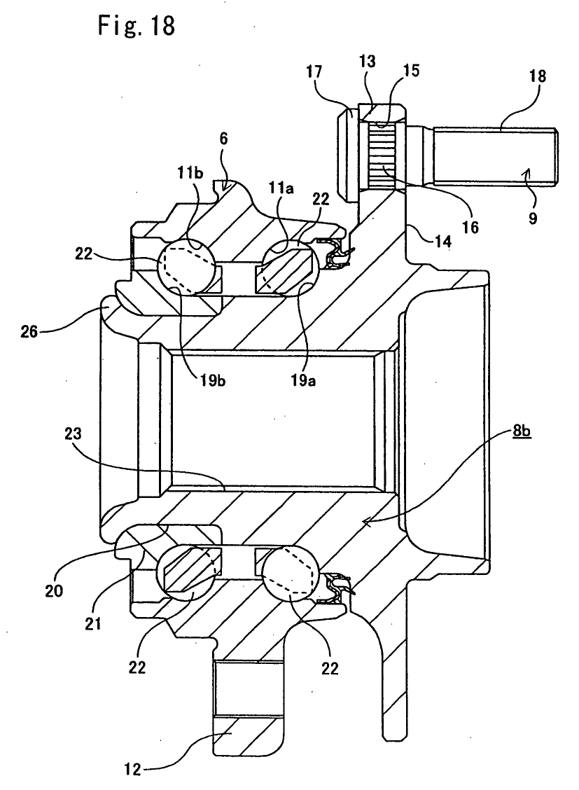

FIG. 1 through FIG. 6 show a first example of the present invention. In the case of this example, at first a hub 8b as shown in FIG. 1 is prepared. This hub 8b is for constructing the aforementioned wheel support rolling bearing unit shown in FIG. 18, and is formed with unfinished holes 29 in a plurality of locations at equal spacing around the circumferential direction of the mounting flange 13. Such a hub 8b is made by executing machining processing such as forge processing, cutting, boring, spline machining, grinding and so on, and surface treatment such as heat treatment and coating processes, similar to for the manufacturing methods of the hub which are typically performed as heretofore. The inner diameter of the axial middle portion of the respective holes 29 made by boring is smaller than the inner diameter of the mounting holes 15 (refer to FIGS. 4 and 5) after completion. Mortar shaped chamfer portions 30 inclined in a direction of increasing internal diameter towards the opening rim are formed in the axially opposite end opening portions. Both these chamfer portions 30 are not really necessary, and one or both chamfers may be omitted. Alternatively, instead of the chamfers in the open end portions of the unfinished holes 29, countersinks may be formed.

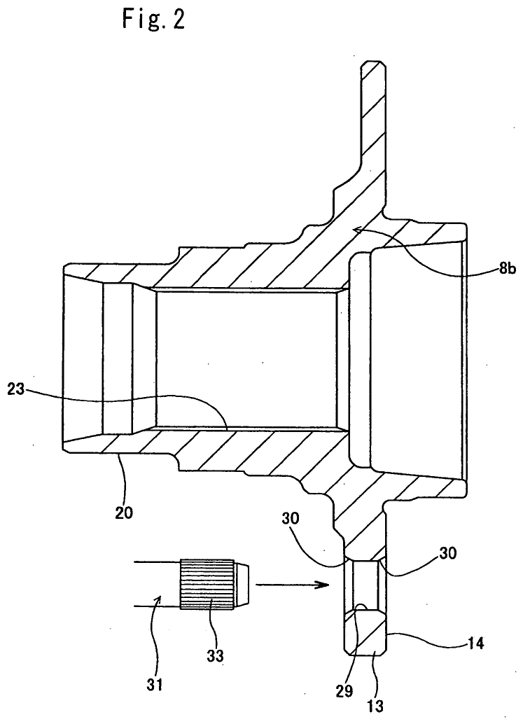

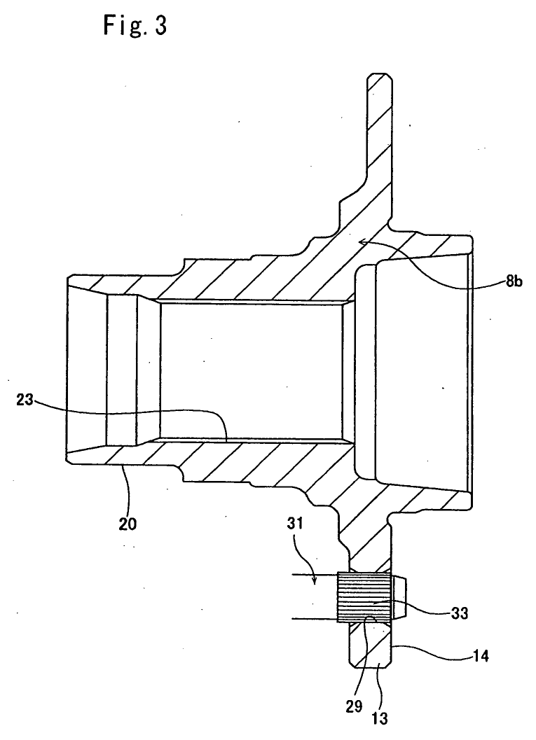

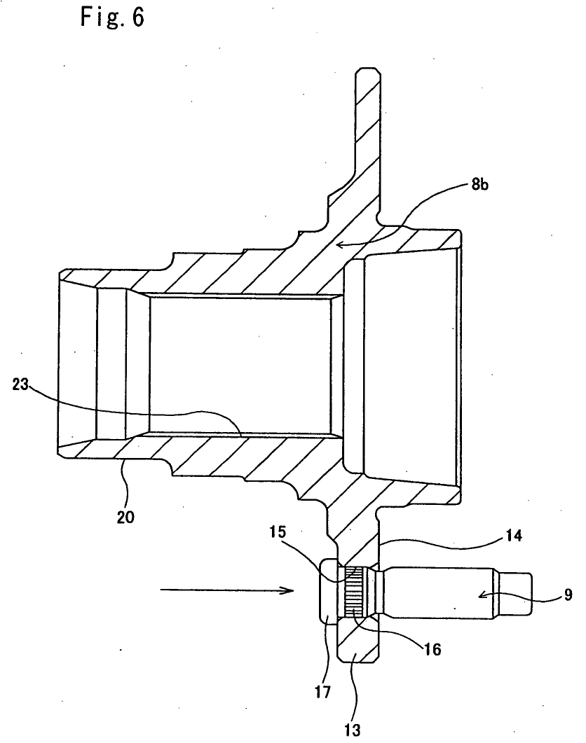

As shown in FIG. 2 to 4, the unfinished holes 29 are made into mounting holes 15. At first, as shown in FIGS. 2 and 3, a processing jig 31 is press fitted into the unfinished hole 29. This processing jig 31 is made from a metal which is harder than the metal material forming the hub 8b (for example cemented carbide steel, high speed steel, die steel, bearing steel). By subjecting the processing jig 31 to surface treatment such as a coating in order to improve the wear resistance, the tool life of the processing jig 31 can be extended, and female serrations 32 having high dimensional accuracy and surface roughness can be provided. On the outer peripheral surface of the tip end portion of the processing jig 31 is provided a processing male serration portion 33 for forming the female serrations 32 (refer to FIGS. 4 and 5) on the inner peripheral surface of the unfinished hole 29. The outer diameter of the other portion of the processing jig 31 is smaller than the core diameter of the processing male serration portion 33. Furthermore, the diameter of the processing male serration portion 33 (addendum circle diameter, pitch circle diameter, core diameter) is made slightly larger than the diameter of the male serration portion 16 (refer to FIG. 6) provided on the portion towards the base end of the middle portion of the stud 9, to be internally fitted into the mounting hole 15. The extent that the diameter of the processing male serration portion 33 is made larger than the diameter of the male serration portion 16, is kept as little as possible within a range where processing errors such as of the stud 9, and the wears accompanying repetitive use of the processing male serration portion 33 do not reverse the larger-smaller relationship between the two male serration portions 16 and 33. In any case, the diameter of the processing male serration portion 33 is not smaller than that of the male serration portion 16. In general, if the diameter of the processing male serration portion 33 is approximately 0.1 mm larger than the diameter of the male serration portion 16, then this is sufficient. However, if spring back accompanying processing is taken into consideration, then this may be a slightly larger value (for example 0.2 mm). In either case, it is easy to determine the diameter of the processing male serration portion 33 by considering the results of a several experiments. At this time, not only is the diameter measurement set, but also the settings for the processing male serration portion 33 are performed by also considering the so called tooth pressure measurement and the contact angle among the parameters of the male serration portion 16, based on the results of these experiments.

By moving the processing male serration portion 33 of the processing jig 31 from the condition shown in FIG. 2 to the condition shown in FIG. 3, and pressing the processing male serration portion 33 into the unfinished hole 29, the outer peripheral surface shape of the processing male serration portion 33 is transferred to the inner peripheral surface of the unfinished hole 29. That is to say, the female serrations 32 are formed on the inner peripheral surface of the unfinished hole 29 to thereby make the mounting hole 15. Then, as shown in FIG. 4, the processing jig 31 is extracted from the mounting hole 15. In the example of the figure, the processing jig 31 is moved forward and then back so that the processing jig 31 is extracted from the pressed-in side. However, the processing jig 31 may be moved in only one direction, and the processing jig 31 then extracted from the opposite side to the pressed-in side. In either case, after the processing jig 31 has been extracted, the female serrations 32 are formed on the inner peripheral surface, to thereby make the mounting hole 15. The diameter of the female serrations 32 (addendum circle diameter, pitch circle diameter, core diameter) matches with the diameter of the processing male serration portion 33 (in the case there being no spring back), or is slightly larger than the diameter of the male serration portion 16. In the case where spring back cannot be ignored, the diameter of the processing male serration portion 33 is set slightly larger, and hence in this case also, the diameter of the female serrations 32 is slightly larger than the diameter of the male serration portion 16.

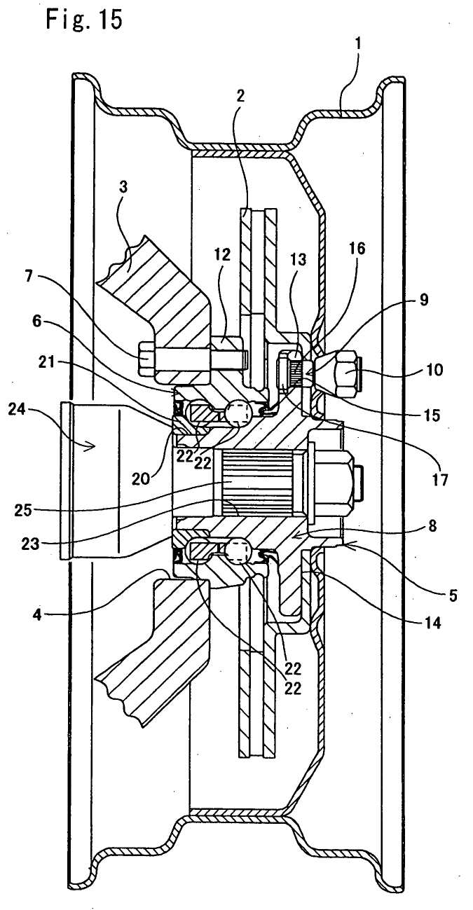

In any case, when the processing male serration portion 33 is pressed into the unfinished hole 29 (press fitted) to make the mounting hole 15 having the female serrations 32 on the inner peripheral surface, the peripheral portion of the unfinished hole 29 being a portion of the mounting flange 13 is nevertheless slightly distorted (deformed). If the wheel support rolling bearing unit is assembled with this distortion unremoved, then as above-mentioned, the axial runout of the rotor 2 (refer to FIG. 15) which is securely connected to the mounting surface 14 of the mounting flange 13 becomes large, and problems such as above-mentioned arise.

Therefore, in the case of this example, after extracting the processing jig 31 from the mounting hole 15, then as shown in FIG. 5, the mounting surface 14 is subjected to a finishing process, so that the mounting surface 14 is made a flat surface in a direction perpendicular to the rotation axis of the hub 8b. All finishing process for the mounting surface 14 of whatever method can be adopted, and in the case of the present example, the finishing process is performed by cutting (turning). Then, the mounting surface 14 is made into a highly accurate flat surface in the direction perpendicular to the rotation axis. As the method of finishing, machining other than cutting such as grinding, or plastic working such as burnishing may also be adopted. No matter what method is adopted, the mounting surface 14 can be processed to a highly accurate flat surface existing in the direction perpendicular to the rotation axis.

In the above manner, once the mounting surface 14 has been made into a highly accurate flat surface existing in the direction perpendicular to rotation axis, the male serration portion 16 provided in the portion towards the base end of the middle portion of the stud 9 is fitted into the mounting hole 15. At this time, the stud 9 is inserted from the tip end thereof into the mounting hole 15 from the opposite side (axial inside) to the mounting surface 14, and the male serration portion 16 and the female serrations 32 are engaged by the serrations. As described above, since the diameter of the male serration portion 16 is less than the diameter of the female serrations 32, the male serration portion 16 is engaged in the female serrations 32 with a loose fit (however in a condition where relative rotation is prevented). Consequently, there is no deformation of the mounting flange 13 accompanying engagement of the serrations of the male serration portion 16 and the female serrations 32, so that the mounting surface 14 maintains the high accuracy flat surface.

However, since there is this engagement with the loose fit, there is a possibility of the stud 9 dropping out from the mounting hole 15. Therefore, in the case of this example, the male serration portion 16 and the female serrations 32 are bonded with an adhesive, so that the stud 9 cannot come out from the mounting hole 15. That is to say, in the case of this example, due to the serration engagement of the male serration portion 16 and the female serrations 32, when the stud 9 and the nut 10 (refer to FIG. 15) are screwed together and tightened, co-rotation of the stud 9 is prevented, and by means of the bond, the stud 9 is prevented from coming out.

The hub 8b with the base end portion of the studs 9 secured to the mounting holes 15 in the above manner, is then assembled with the outer ring 6, the rolling elements 22, and the inner ring 21, to give the aforementioned wheel support rolling bearing unit as shown in FIG. 18. Furthermore, as necessary, a rotation speed detection sensor for obtaining a signal for anti-lock braking system (ABS) control, and a cap for covering the outside end opening of the hub 8b (neither shown in the drawings) are assembled.

In the case where a rotor 2 is connected and secured to the mounting surface 14 of the mounting flange 13 fitted to the wheel support rolling bearing unit of this example, obtained as described above, axial direction oscillations of the braking friction surface of the rotor 2 can be kept to a minimum. Therefore, the aforementioned partial wear of the pads and the braking friction surfaces, and the abnormal noise referred to as judder which occurs at the time of braking, can be suppressed.

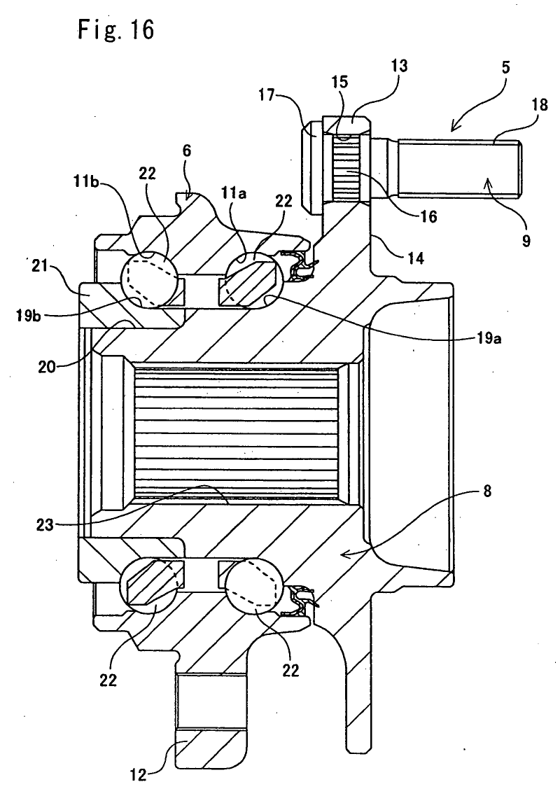

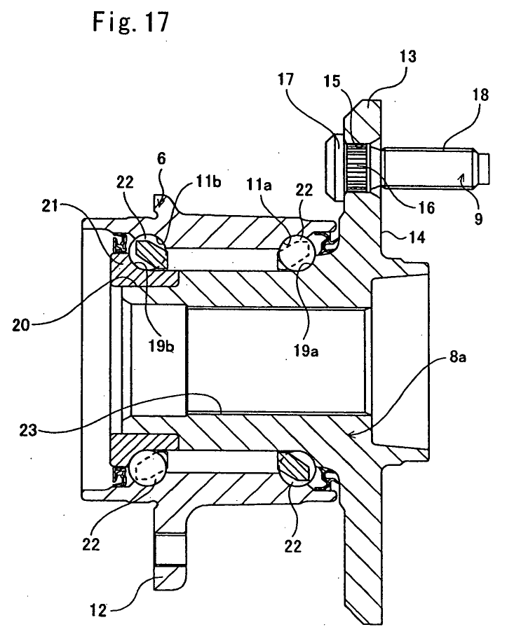

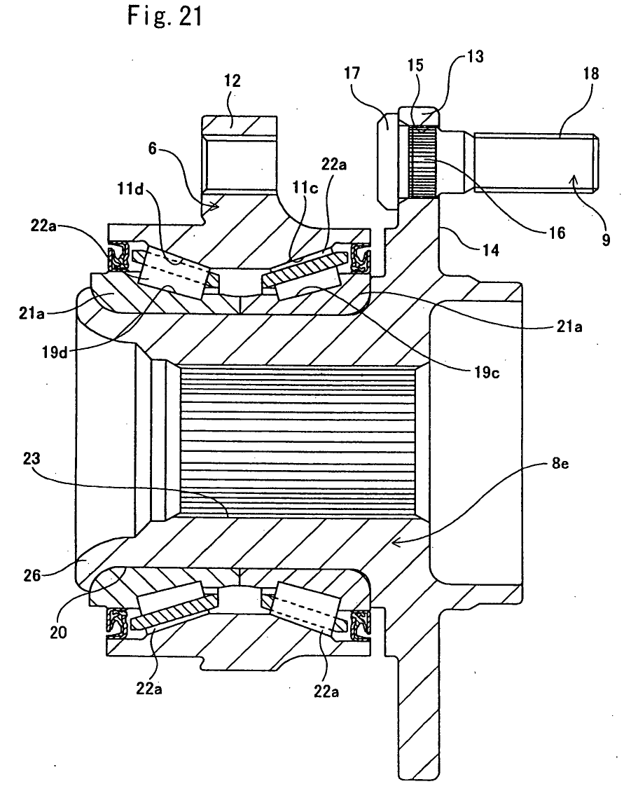

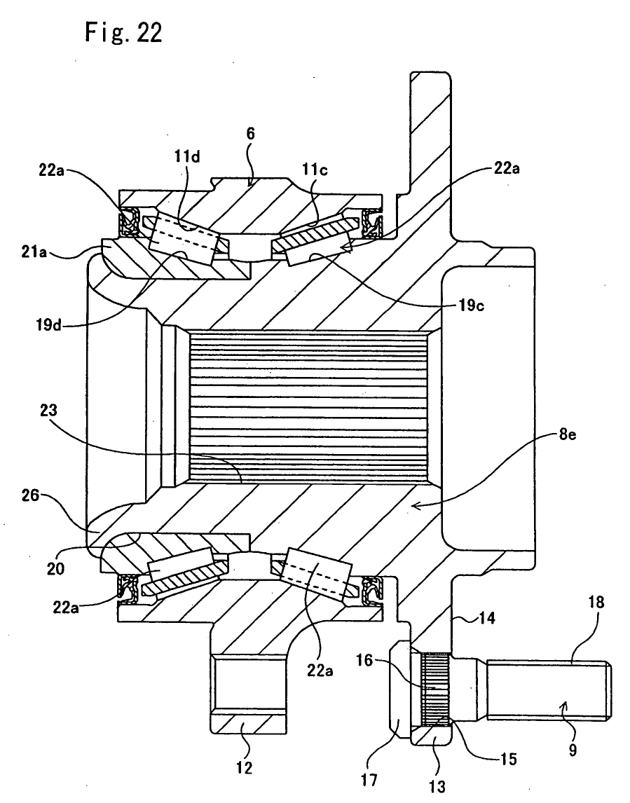

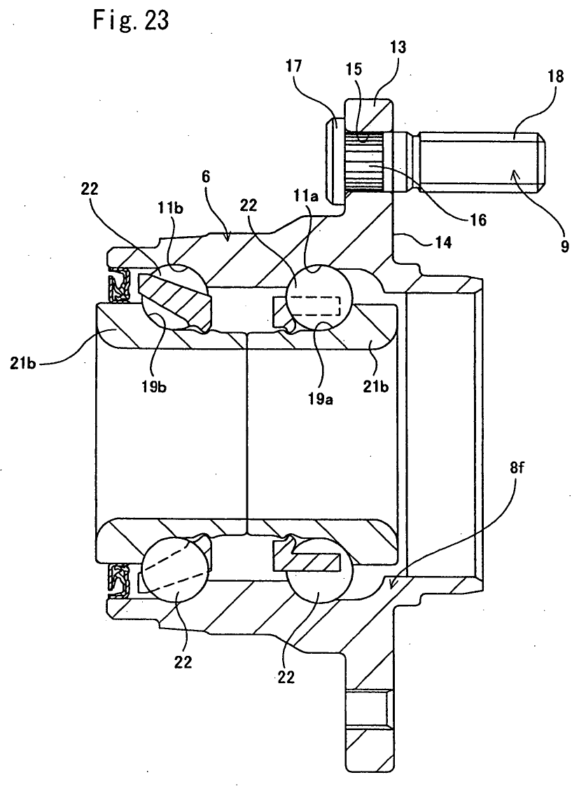

The above embodiment has been illustrated for the case where the present invention is applied to the construction shown in FIG. 18. However the present invention is not limited to the construction shown in FIG. 18, and can also be applied to wheel support rolling bearing units of various constructions having a mounting flange on the outer peripheral surface of the rotation ring, including those of the aforementioned FIGS. 16 and 17, and 19 to 23.

### Second Example

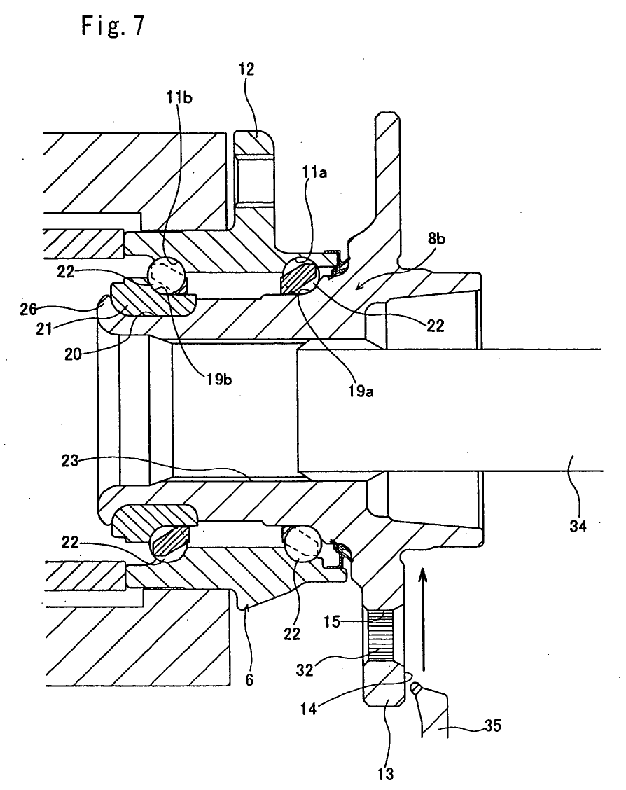

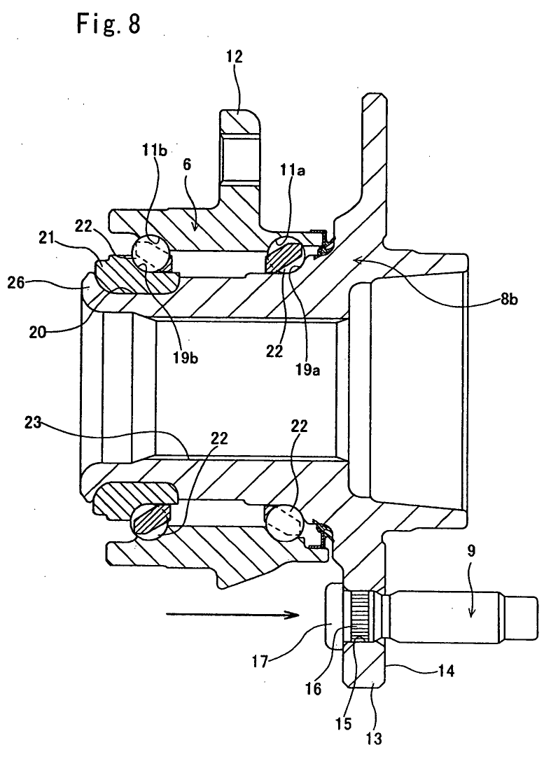

FIGS. 7 and 8 show a second example of the present invention. In the case of this example also, as with the case of the first example, the female serrations 32 are formed by the process shown in FIG. 2 to 4, on the inner peripheral surface of the mounting hole 15 of the mounting flange 13 which is formed on the outer peripheral surface of the hub 8b. The process up this point is the same as for the first example, and hence repeated description is omitted. The feature of this example is that, after forming the female serrations 32 on the inner peripheral surface of the mounting hole 15, the mounting surface 14 of mounting flange 13 is processed to a high accuracy, that is, the mounting surface 14 is made into a flat surface existing in the direction perpendicular to the rotation axis of the hub 8b.

That is to say, in the case of this example, after forming the female serrations 32 on the inner peripheral surface of the mounting hole 15, and before subjecting the mounting surface 14 to finishing processing, the finished product of the wheel support rolling bearing unit or the semi-finished product as shown in FIG. 7, is assembled by assembling the hub 8b with the other members, that is, the outer ring 6, the rolling elements 22, and the inner ring 21. Then in the condition as shown in FIG. 7 with the outer ring 6 secured, the hub 8b is rotated. Therefore, in the case of this example, the tip end portion of a driven shaft 34 is spline engaged in the spline hole 23 provided in the central portion of the hub 8b. Then, while rotating the hub 8b with the driven shaft 34, the mounting surface 14 is subjected to burnishing by pressing a burnishing cutter 35 against the mounting surface 14. At this time, the outer ring 6 can be also be rotated at a slower speed than the hub 8b. By rotating the outer ring 6 at a slow speed, the load accompanying the pressing of the burnishing cutter 35, is applied evenly around the whole periphery of the outer ring raceway 11a and 11b provided on the inner peripheral surface of the outer ring 6, so that the occurrence of damage such as indentations in part of the two outer ring raceways 11a and 11b can be more reliably prevented.

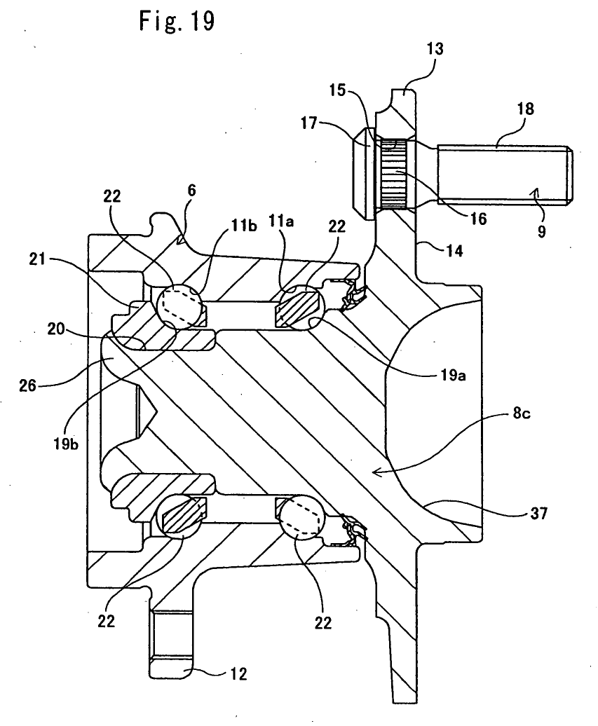

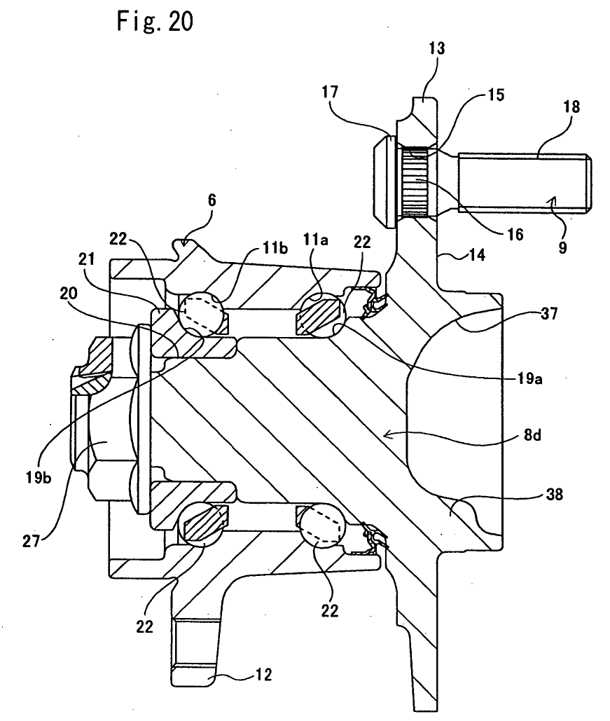

The method of subjecting the mounting surface of the mounting flange to burnishing while rotating the hub after assembling in the finished product or semi-finished product of the wheel support rolling bearing unit, as with this example, is not limited to the construction as shown in FIGS. 7 and 8 where the spline hole 23 is provided in the central portion of the hub 8b, and is also applicable to a wheel support rolling bearing unit for an undriven wheel as shown before in FIGS. 19 and 20. However, in the case of the wheel support rolling bearing unit for an undriven wheel, then different to the wheel support rolling bearing unit for an driven wheel, the spline hole is not provided in the central portion of the hub, and hence the hub cannot be rotated by the driven shaft 34 provided with the male spline portion as shown in FIG. 7. Therefore, a driven shaft is used which can be friction engaged with the inner face of a concavity 37 (refer to FIG. 19) formed in the central portion of the outside end surface of the hub so that the hub can be rotated. Or as shown in FIG. 20, a convexity 38 which protrudes radially inwards is provided on one part around the circumferential direction of the concavity 37, and one part of the driven shaft is mechanically engaged with the convexity 38 to thereby rotate the hub.

In either case, in the present example, after the hub 8 has been actually assembled in the wheel support rolling bearing unit, the mounting surface 14 is subjected to finish processing. Therefore, the mounting surface 14 can be matched highly accurately on the virtual plane perpendicular to the rotation axis of the hub 8b, even if there being erroneous assembly of the related respective members (the hub 8b, the outer ring 6, the rolling elements 22) which constitute the wheel support rolling bearing unit. Furthermore, in the case of this example, since the finishing processing for the mounting surface 14 is performed by burnishing, there is no occurrence of shavings accompanying the finishing process, and the mounting surface 14 can be made to conform with high accuracy to the virtual plane perpendicular to the rotation axis of the hub 8b. Moreover, the occurrence of the aforementioned undesirable condition accompanying adhesion of the chips to the mounting surface 14 does not arise. After subjecting the mounting surface 14 to the finishing process, then as shown in FIG. 8, the male serration portion 16 provided on the base end portion of the stud 9 is fitted into the mounting hole 15.

Details other than this are the same as for the first example, and repeated description is omitted.

### Third Example

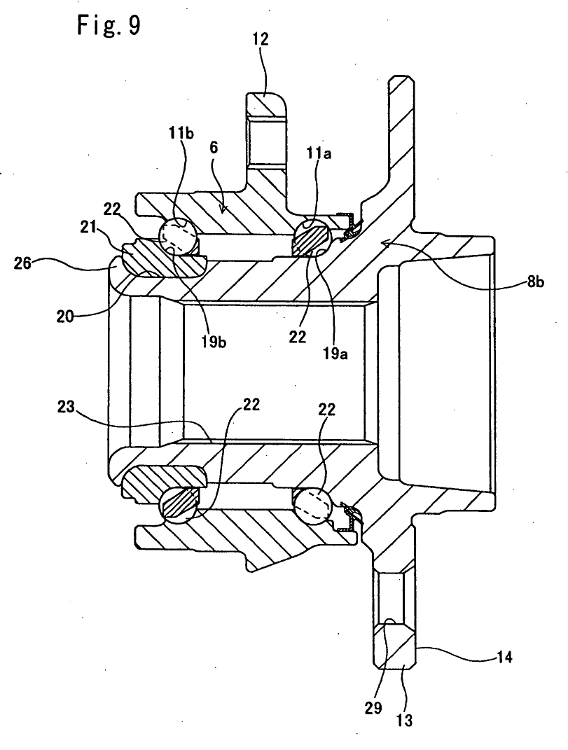

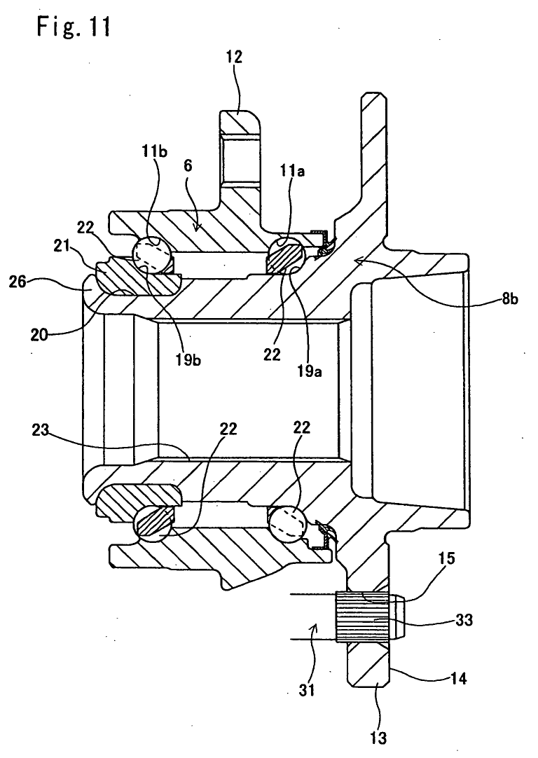

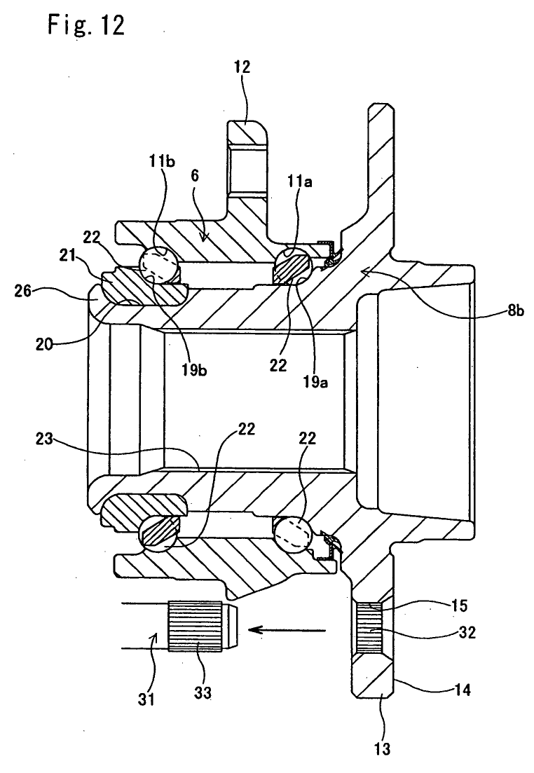

FIG. 9 through 12 show a third example of the present invention. In the case of this example, the aforementioned hub 8b shown in FIG. 2 formed with the unfinished holes 29 (the female serrations 32 not yet formed in the inner peripheral surface) in the mounting flange 13, is assembled with the other members, namely the outer ring 6, the rolling elements 22, the inner ring 21 or the like, and is assembled into a finished product or a semi-finished product of the wheel support rolling bearing unit shown in FIG. 9.

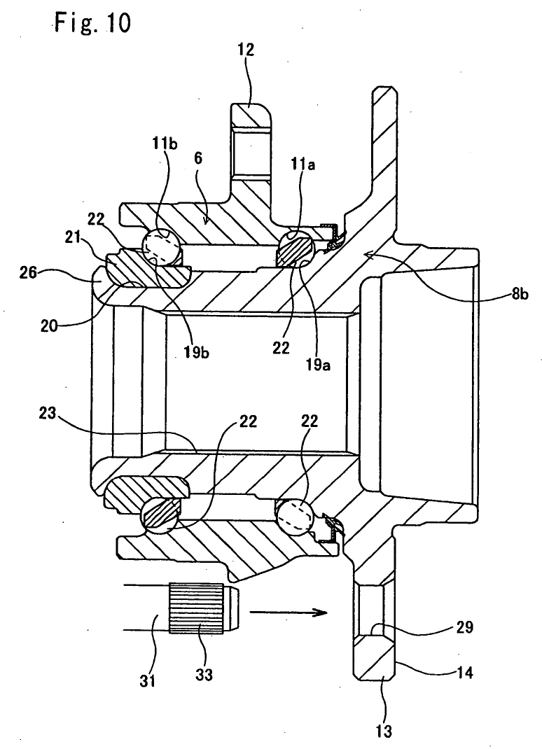

Next, as shown in FIG. 10 through 12, the processing male serration portion 33 of the processing jig 31 is press fitted into the unfinished hole 29, and the female serrations 32 are formed on the inner peripheral surface of the unfinished hole 29, thereby making the mounting holes 15. In the process of making the unfinished holes 29 into the mounting holes 15 in this manner, the details other than that this is performed after the hub 8b is assembled with the other members, are the same as for the aforementioned first example and second example. If the unfinished holes 29 are processed into the mounting holes 15 in this manner, then similarly to the aforementioned second example, as shown in FIG. 7 the mounting surface 14 of mounting flange 13 is subjected to burnishing, and the mounting surface 14 is made to match highly accurately on the virtual plane perpendicular to the rotation axis of the hub 8b. Then the mounting surface 14 is subjected to finishing processing, after which, as shown in FIG. 8, the male serration portion 16 provided on the base end portion of the stud 9 is fitted into the mounting hole 15.

The details other than that the process of making the unfinished hole 29 into the mounting hole 15 is performed after assembly of the hub 8b with the other members, are the same as for the aforementioned second example including the effects due to burnishing, and hence repeated description is omitted.

In each of the above described examples, the female serrations 32 are formed on the inner peripheral surface of the unfinished hole 29 by pressing the processing jig 31 into the unfinished hole 29. However, the method of forming the female serrations 32 is not limited to this method. For example, by strongly pressing a processing jig having an appropriate shape, into a mounting flange which is not formed with the unfinished holes, so as to subject this to plastic working at the same time as a punching process, then mounting holes formed with the female serrations on the inner peripheral surface equivalent to those made by pressing the processing jig 31 into the unfinished hole 29 as mentioned above, can be formed. If the mounting holes are made by the abovementioned method, then the unfinished hole processing can be omitted, so that the mounting holes can be formed in a single step. Therefore this is advantageous from the point of production cost reduction. Furthermore, after performing punching or plastic working for processing the unfinished holes, then similarly to the case of the aforementioned respective examples, mounting holes provided with female serrations on the inner peripheral surface equivalent to the case of the respective examples, can be also formed with a processing jig having a processing male serration portion.

### Fourth Example

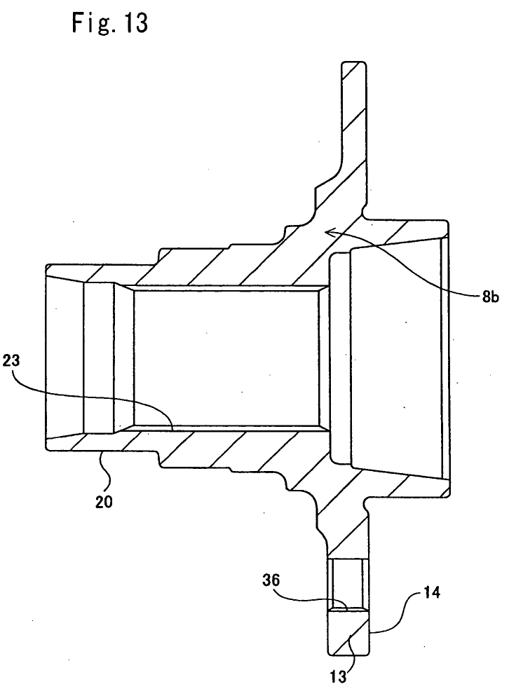

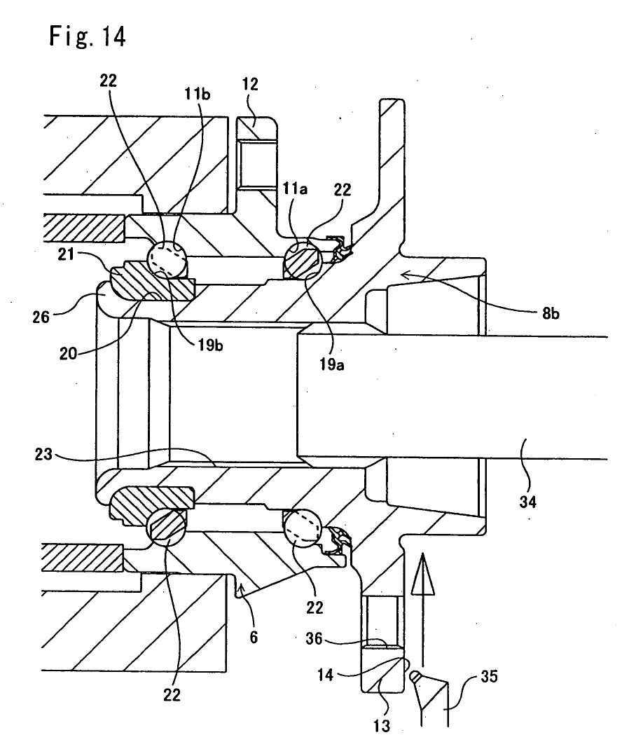

FIGS. 13 and 14 show a fourth example of the present invention. In the case of this example, threaded holes 36 are formed piercing through the mounting flange 13 of the hub 8b in the axial direction, at a plurality of locations evenly spaced around the circumferential direction of the mounting flange 13. Also in relation to this mounting flange 13 of the hub 8b, with the processing of the threaded holes 36 the accuracy of the mounting surface 14 is possibly impaired, although not to the extent where the base end portion of the stud is inserted. Therefore, in the case of this example, the hub 8b is assembled with the other members, that is the outer ring 6, the rolling elements 22, the inner ring 21 or the like, and in the assembled condition of the wheel support rolling bearing unit finished product or semi-finished product as shown in FIG. 14, a burnishing cutter 35 is pressed against the mounting surface 14 while rotating the hub 8b, so that the mounting surface 14 is subjected to burnishing, and the mounting surface 14 is made to match with high accuracy to the virtual plane perpendicular to the rotation axis of the hub 8b.

In the case of this example, by screwing and tightening the bolts which are inserted inwards from the outside of the wheel 1 and the rotor 2 into the threaded holes 36, the wheel 1 and the rotor 2 are connected and secured to the mounting flange 13.

Other construction and operation are the same as for the aforementioned second example including the effects due to burnishing, and hence repeated description is omitted.

1. A wheel support rolling bearing unit comprising:
a stationary ring and a rotating ring combined together concentric with each other and are rotatably supported relative to each other via a plurality of rolling elements,
a flange provided on an outer peripheral surface of the rotating ring for fixedly supporting a wheel and a brake rotation member on a mounting surface being an axial side surface thereof, and
mounting holes provided at a plurality of locations around the circumferential direction of the flange in a condition axially piercing the flange,
wherein the mounting surface is made a flat surface perpendicular to the rotation axis of the rotating ring, by burnishing which is applied in a condition with the stationary ring, the rotating ring and the rolling elements assembled together.

2. A manufacturing method for a wheel support rolling bearing unit comprising:
a stationary ring and a rotating ring combined together concentric with each other and are rotatably supported relative to each other via a plurality of rolling elements,
a flange provided on an outer peripheral surface of the rotating ring for fixedly supporting a wheel and a brake rotation member on a mounting surface being an axial side surface thereof, and
mounting holes provided at a plurality of locations around the circumferential direction of the flange in a condition axially piercing the flange, and in which the mounting surface is made a flat surface perpendicular to the rotation axis of the rotating ring,
wherein the manufacturing method comprising making the mounting surface of the flange a flat surface by subjecting the mounting surface to burnishing in a condition with the stationary ring, the rotating ring and the rolling elements assembled together.

3. A wheel support rolling bearing unit comprising:
a stationary ring and a rotating ring combined together concentric with each other and rotatably supported relative to each other via a plurality of rolling elements,
a flange provided on an outer peripheral surface of the rotating ring for fixedly supporting a wheel and a brake rotation member on a mounting surface being an axial side surface thereof,
mounting holes provided at a plurality of locations around the circumferential direction of the flange in a condition axially piercing the flange, and formed with female serrations on the inner peripheral surface thereof, and
a plurality of studs supported in the flange by fitting male serration portions provided on base end portions thereof into the mounting holes,
wherein the female serrations on the inner peripheral surface of the mounting holes are formed by inserting a processing jig having a diameter which is larger than that of the male serration portions provided on the base end portions of the studs into a plurality of unfinished holes formed in the flange, in a direction towards the mounting surface from the surface on the opposite side to the mounting surface,
and then the mounting surface is made into a flat surface perpendicular to the rotation axis of the rotating ring by finishing which is applied after forming the female serrations by means of the processing jig, in the inner peripheral surface of the mounting holes.

4. A manufacturing method for a wheel support rolling bearing unit comprising:
a stationary ring and a rotating ring combined together concentric with each other and rotatably supported relative to each other via a plurality of rolling elements,
a flange provided on an outer peripheral surface of the rotating ring for fixedly supporting a wheel and a brake rotation member on a mounting surface being an axial side surface thereof,
mounting holes provided at a plurality of locations around the circumferential direction of the flange in a condition axially piercing the flange, and formed with female serrations on the inner peripheral surface thereof, and
a plurality of studs supported in the flange by fitting male serration portions provided on base end portions thereof into the mounting holes, and in which the mounting surface of the flange is made into a flat surface perpendicular to the rotation axis of the rotating ring,
wherein the manufacturing method comprising:
forming the female serrations on the inner peripheral surface of the mounting holes by inserting a processing jig having a diameter which is larger than that of the male serration portions provided on the base end portions of the studs into a plurality of unfinished holes formed in the flange, in a direction towards the mounting surface from the surface on the opposite side to the mounting surface,
then making the mounting surface a flat surface perpendicular to the rotational axis of the rotating ring by subjecting the mounting surface to finishing, and
then fitting the base end portion of the studs into the mounting holes.

5. A wheel support rolling bearing unit comprising:
a stationary ring and a rotating ring combined together concentric with each other and rotatably supported relative to each other via a plurality of rolling elements,
a flange provided on an outer peripheral surface of the rotating ring for fixedly supporting a wheel and a brake rotation member on a mounting surface being an axial side surface thereof,
mounting holes provided at a plurality of locations around the circumferential direction of the flange in a condition axially piercing the flange, and formed with female serrations on the inner peripheral surface thereof,
and a plurality of studs supported in the flange by fitting male serration portions provided on base end portions thereof into the mounting holes,
wherein the female serrations on the inner peripheral surface of the mounting holes are formed in a larger diameter than that of the male serration portions, by broaching the plurality of unfinished holes formed in the flange, and the mounting surface is made into a flat surface perpendicular to the rotational axis of the rotating ring, by finishing processing which is applied after forming the female serrations by the broaching on the inner peripheral surface of the mounting holes.

6. A manufacturing method for a wheel support rolling bearing unit comprising:
a stationary ring and a rotating ring combined together concentric with each other and rotatably supported relative to each other via a plurality of rolling elements,
a flange provided on an outer peripheral surface of the rotating ring for fixedly supporting a wheel and a brake rotation member on a mounting surface being an axial side surface thereof,
mounting holes provided at a plurality of locations around the circumferential direction of the flange in a condition axially piercing the flange, and formed with female serrations on the inner peripheral surface thereof, and
a plurality of studs supported in the flange by fitting male serration portions provided on base end portions thereof into the mounting holes, and in which the mounting surface is made into a flat surface perpendicular to the rotational axis of the rotating ring,
wherein the manufacturing method comprising:
forming female serrations on the inner peripheral surface of the mounting holes with a larger diameter than that of the male serration portions by broaching the plurality of unfinished holes formed in the flange, then making the mounting surface into a flat surface perpendicular to the rotation axis of the rotating ring by subjecting the mounting surface to finishing, and then fitting the base end portions of the studs into the mounting holes.

7. A wheel support rolling bearing unit according to any one of claim 3 and claim 5, wherein a retaining means for preventing the base end portion of the studs from coming out from the mounting holes, is provided between the mounting holes and the studs.

8. A wheel support rolling bearing unit according to claim 7, wherein the retaining means is an adhesive which bonds the male serration portion to the female serrations.

9. A wheel support rolling bearing unit according to claim 7, wherein the retaining means is an O-ring externally fitted to a portion of the stud which protrudes from the mounting surface of the flange, at an intermediate portion of the stud, and a chamfer or countersink is formed in the peripheral portion of the opening of the mounting hole on the mounting surface side, in order to accommodate the O-ring in at least an elastically compressed condition.

10. A manufacturing method for a wheel support rolling bearing unit according to either one of claim 4 and claim 6, wherein finishing process for the mounting surface is performed while rotating the rotating ring with respect to the stationary ring, with the stationary ring, the rotating ring, and the rolling elements assembled together.
